(19) United States
(12) Patent Application Publication
(10) Pub. No.: US 2019/0191026 A1
(43) Pub. Date: Jun. 20, 2019

(54) MOBILE PHONE INHIBITION

(71) Applicant: MCELREA HOLDINGS GROUP PTY LTD, Brisbane (AU)

(72) Inventor: Andrew John Roderick McElrea, Brisbane (AU)

(21) Appl. No.: 16/283,166

(22) Filed: Feb. 22, 2019

Related U.S. Application Data
(63) Continuation-in-part of application No. PCT/AU2017/050794, filed on Jul. 31, 2017.

(30) Foreign Application Priority Data
Aug. 23, 2016 (AU) 2016903336

(51) Int. Cl. H04M 1/725; H04W 4/02; H04W 4/48; H04W 4/80

(52) U.S. Cl. CPC H04M 1/72577; H04W 4/80; H04W 4/48; H04W 4/027

(57) ABSTRACT

The present invention relates to a telecommunications system. The system includes a mobile phone for use by a driver. A speed determination tool is provided for determining the speed of the mobile phone. The system also includes a telecommunications provider (e.g. Telstra) for inhibiting a function of the mobile phone when the determined mobile phone speed exceeds a predetermined speed. Advantageously, the driver's mobile phone has the function inhibited when the phone exceeds the predetermined speed, which is indicative of driving.

### TECHNICAL FIELD

The present invention generally relates to mobile phone inhibition, particularly for young and fleet vehicle drivers.

### BACKGROUND

The reference to any prior art in this specification is not, and should not be taken as an acknowledgement or any form of suggestion that the prior art forms part of the common general knowledge.

In spite of significant risks and law enforcement penalties, young drivers continue to use their mobile phone when driving. More than twenty five percent of respondents in a recent study were confident they could stop the distraction from texting and driving from affecting their driving ability. Seventeen percent were confident they could text on their phone while driving. Young women in particular believed there was a benefit in texting even when driving.

Whilst there are existing products directed to eliminating the use of mobile phones by drivers, none of these are effective or had any significant impact on driver behavior. One product requires the installation of additional hardware in the vehicle which is expensive and cumbersome. Another allows parents to simply monitor phone activity which is merely a notional deterrent.

The preferred embodiment provides an improved product for impeding the use of a mobile phone by a driver.

### SUMMARY OF THE INVENTION

According to another aspect of the present invention, there is provided a telecommunications system, the system including:

a mobile phone for use by a driver;

a speed determination tool within the phone for determining the speed of the mobile phone; and

a telecommunications company (Telco) (e.g. Telstra) for inhibiting a function of the mobile phone when the determined mobile phone speed exceeds a predetermined speed; and
means for enabling a guardian to configure rules associated with the inhibition applied by the Telco to the mobile phone;

wherein individual control is provided by the guardian over the mobile phone of the driver, and that control is applied by the Telco to the mobile phone.

Advantageously, the driver's mobile phone has the function inhibited when the phone exceeds the predetermined speed, which is indicative of driving.

The system may further include an administration server for administering the system. The administration server may communicate with application software (i.e. Apps) on the phones. The system may further include a notification tool for notifying the guardian's phone about information relating to the driver's phone. The information may relate to disabling an App executing on the driver's phone, disabling location services relating to the driver's phone and upon which the speed of the phone is determined, the driver's phone exceeding a speed or the driver's phone travelling beyond a predefined distance from home.

The system may include an override tool for overriding the inhibition. The overriding tool may override the inhibition when the function relates to a guardian number or when the phone has a Bluetooth connection.

The system may include a selection tool for selecting inhibition options. The inhibition options may relate to the predetermined speed, the function (e.g. call, message), the nature of the function (e.g. receiving or transmitting), or the forum of the function (e.g. social media, facebook, twitter, snapchat, Instagram, e-mail or other like applications).

The system may include a disablement timer for temporarily disabling the inhibition responsive to approval from a guardian.

According to another aspect of the present invention, there is provided a method for inhibiting a function of a driver's mobile phone, the method including:

a telecommunications company (Telco) inhibiting the function when the mobile phone exceeds a predetermined speed determined by the phone; and

the Telco applying enforcement rules to the mobile phone, the enforcement rules being associated with the inhibition and being configured by a guardian;

wherein individual control is provided by the guardian over the mobile phone of the driver, and that control is applied by the Telco to the mobile phone.

The method may involve selecting the function to be inhibited. The method may involve sending a notification to the guardian when disabling a user App executing the method or location services relating to the phone and upon which the speed of the phone is determined. The method may involve sending a notification when a speed is exceeded or when the phone travels beyond a predefined distance from home. The method involves setting a guardian number to receive the notification.

The method may involve overriding the inhibition when the function relates to a guardian number. The method may involve overriding the inhibition when the phone has a Bluetooth connection.

The method may involve setting the predetermined speed from a number of possible speeds. The method may involve selecting the function from a number of possible functions. The function may relate to a message or call. The function may include receiving or transmitting the message or call. The function may relate to social media. The function may relate to facebook, twitter, snapchat, Instagram, e-mail or other like applications.

The method may involve sending a temporary disablement request to a guardian (i.e. when the phone owner is travelling but not driving) to temporarily disable the inhibition. The guardian may deny or allow the request. The guardian may select a length of time to temporarily disable the inhibition. The request may be via App messaging or SMS.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a telecommunications system in accordance with an embodiment of the present invention; and

FIGS. 2a to 2c form a flowchart showing a method for inhibiting a function of a driver's mobile phone of the system of FIG. 1.

### DETAILED DESCRIPTION OF PREFERRED EMBODIMENTS

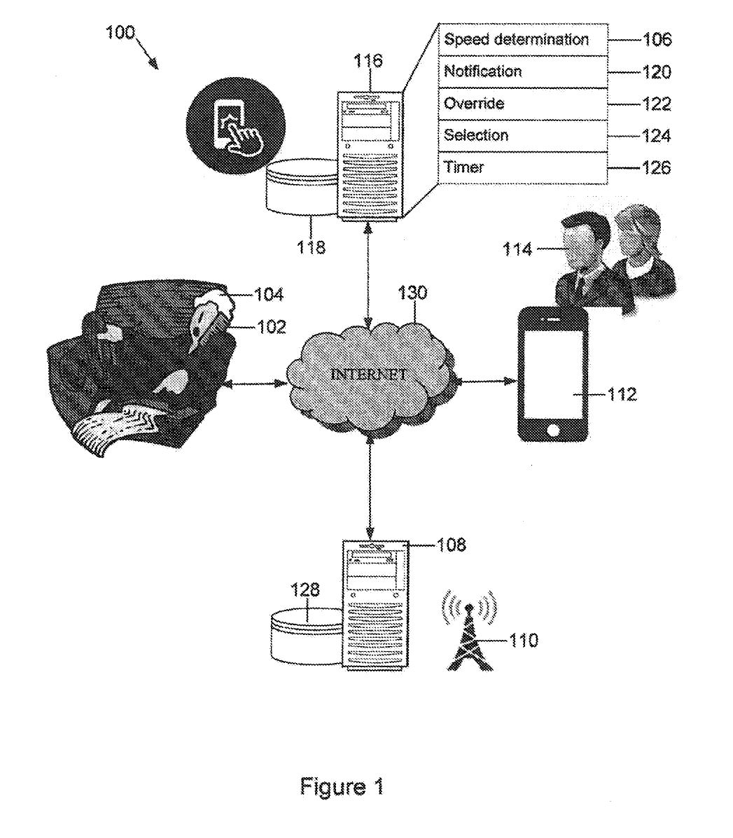

According to an embodiment of the present invention, there is provided a telecommunications system 100 as shown in FIG. 1. The system 100 includes a driver's mobile smartphone 102 for use by a driver 104. The system 100 further includes a speed determination tool 106 for determining the speed of the mobile phone 102. A telecommunications server 108 of telecommunications provider 110 (e.g. Telstra) is configured to inhibit a function (e.g. calling, texting, etc) of the mobile phone 102 when the determined mobile phone speed exceeds a predetermined speed. Advantageously, the driver's mobile phone 102 has the function inhibited when the phone exceeds the predetermined speed, which is indicative of driving.

The system 100 further includes a guardian's smartphone 112 for operation by a guardian 114 (e.g. parent) to enforce rules surrounding the inhibition.

The system 100 further includes an administration server 116 for administering the overall operation of the system 100. The administration server 116 communicates with inhibition application software (i.e. Apps) on both phones 102, 112. An administration database 118 stores an inhibition record associated with the driver 104 and includes account information such as the driver's number, guardian's number, and system parameters.

The system 100 further includes a notification tool 120 for notifying the guardian's phone 112 about information relating to the driver's phone 102. The notification information relates to the driver 102 electing to disable the inhibition App executing on the driver's phone 102, the driver 102 electing to disable location services relating to the driver's phone 102 and upon which the speed of the phone 102 is determined, the driver's phone 102 exceeding a unsafe maximum speed or the driver's phone 102 travelling beyond a predefined radial distance from home which is not permitted by the guardian 114.

The system 100 also includes an override tool 122 for overriding the inhibition. The overriding tool 122 can override the inhibition when the function relates to a guardian number so that the phone 102 receives texts and calls from the guardian 114 or when the phone 102 has a Bluetooth connection indicating hands-free operation.

The system 100 also includes a selection tool 124 for selecting various inhibition options. The inhibition options relate to the predetermined speed, the function (e.g. call, message), the nature of the function (e.g. receiving or transmitting), or the forum of the function (e.g. social media, facebook, twitter, snapchat, Instagram, e-mail or other like applications).

The system 100 also includes a disablement timer 126 for temporarily disabling the inhibition responsive to approval from a guardian 114 when the driver 104 is actually a passenger and no longer driving the vehicle.

A telecommunications database 128 stores a driver's record in the form of phone account. The driver's record includes the driver's number, and the one or more functions currently inhibited. Administration server 116 communicates with the phones 102, 112 and the telecommunications server 108 via the Internet 130. In particular, the administration server 116 instructs setting of the inhibition functions associated with the driver's number in the telecommunications database 128, and the telecommunications server 108 inhibits those functions to the driver's phone 102 accordingly.

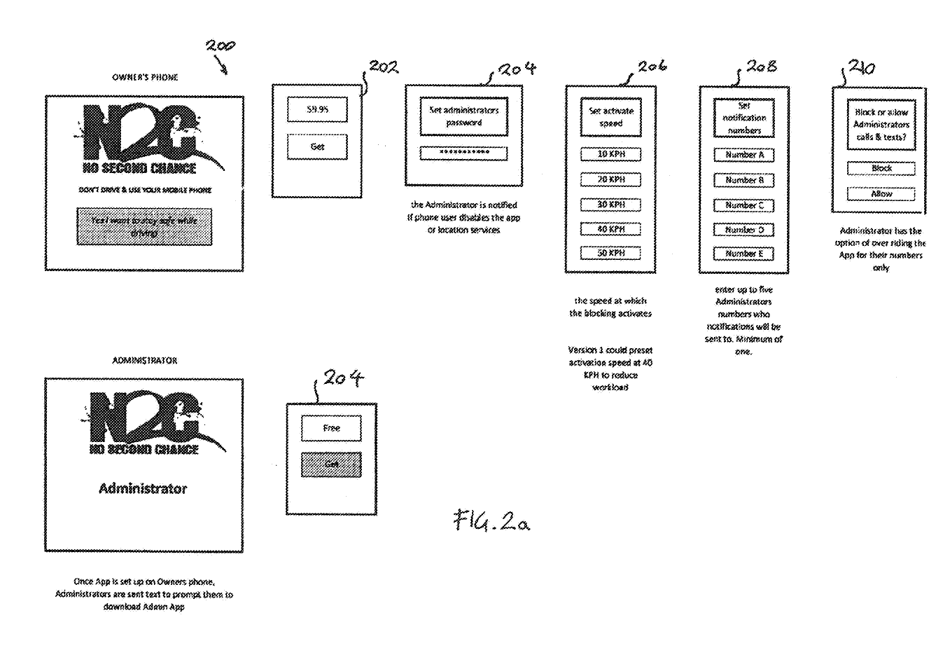

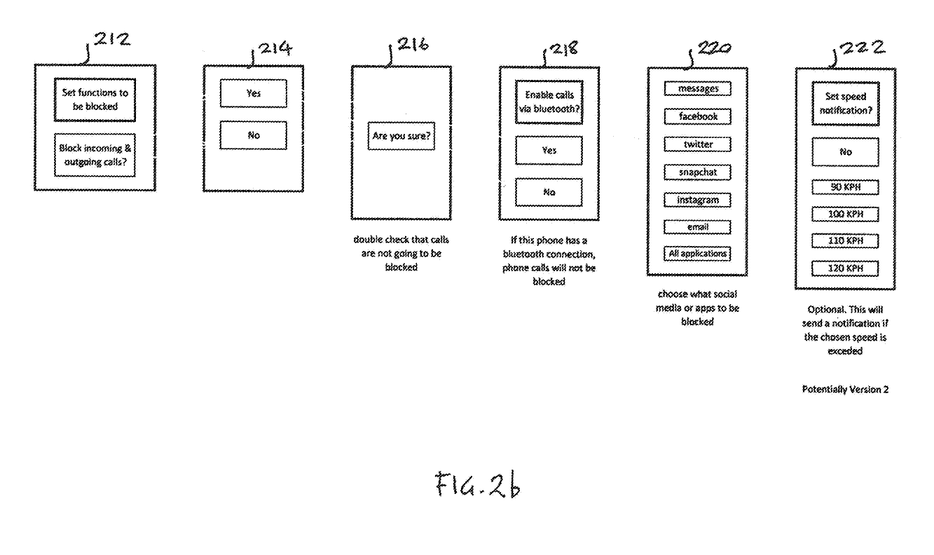

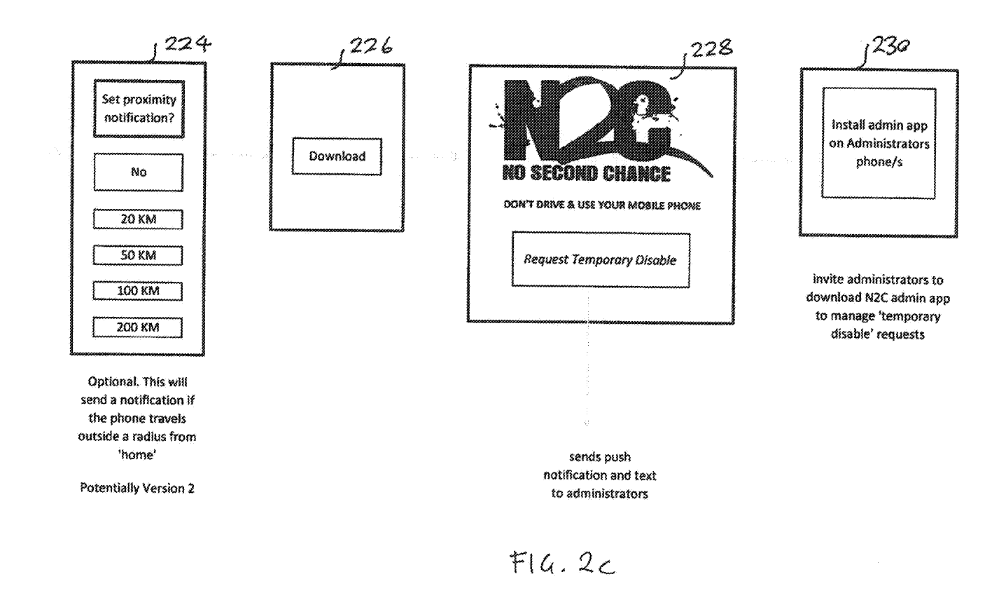

A method 200 for inhibiting a function of the driver's mobile phone 102 is now described with reference to FIG. 2.

At step 202, the driver 104 downloads the inhibition App from the administration server 118 (or another server) and onto smartphone 102. In parallel at step 204, the guardian 114 downloads the inhibition App from the administration server 116 and onto smartphone 112. The App may be downloaded responsive to making a payment.

At step 204, the guardian 114 sets a password for the administration server 116. The notification tool 120 of the administration server 116 sends a notification to the guardian's phone 112 when the driver 104 disables on their phone 102 either the inhibition App or location services (e.g. including phone GPS) relating to the phone 102 and upon which the speed of the phone is determined.

At step 206, the guardian 114 with phone 112 uses the selection tool 124 to set the predetermined phone speed (e.g. 20 km/hr), from a number of possible speeds, at which the phone function inhibition occurs.

At step 208, the guardian 114 with phone 112 uses the selection tool 124 to set at least one guardian number to receive notifications from the notification tool 120.

At step 210, the guardian 114 with phone 112 can use the override tool 122 for overriding the inhibition when the function relates to a guardian number. In this manner, the guardian 114 is never prevented from communicating with the driver 104 even during driving.

At step 212, the guardian 114 with phone 112 uses the selection tool 124 to select the functions to be inhibited from a number of possible functions. The functions typically relate to sending or receiving a message or call.

At steps 214 and 216, the guardian 114 with phone 112 confirms and reconfirms the functions to inhibited or blocked.

At step 218, the guardian 114 with phone 112 uses the overriding tool 122 to override the inhibition when the phone 102 has a Bluetooth connection indicating hands-free operation.

At step 220, the guardian 114 with phone 112 uses the selection tool 124 to select other social media functions to be inhibited. The social media functions relate to facebook, twitter, snapchat, Instagram, e-mail or other like applications.

At step 222, the guardian 114 with phone 112 uses the notification tool 120 to enable receipt of a speed notification on the guardian's phone 112 when the driver's phone 102 exceeds an unsafe maximum speed. The phone speed is determined using the locality settings and GPS of the phone 102.

At step 224, the guardian 114 with phone 112 uses the notification tool 120 to enable receipt of a distance notification on the guardian's phone 112 when the driver's phone 102 travels beyond a predefined radial distance from home, which is not permitted by the guardian 114. The phone location and distance from home is determined using the locality settings and GPS of the phone 102.

At step 226, the guardian 114 with phone 112 save the foregoing settings to the driver's inhibition record in the administration database 118. In turn, the driver's mobile phone 102 operates in accordance with the stored settings.

At step 228, the driver 104 with phone 102 uses the timer 126 for requesting temporary disablement of the inhibition and for approval from the guardian 114 when the driver 104 is actually a passenger and no longer driving the vehicle. A temporary disablement request is pushed to the guardian 114 to temporarily disable the inhibition. The guardian 114 denies or allows the request with their phone 112. The guardian 114 can select a length of time (e.g. hours, days, weeks) from many possibilities to temporarily disable the inhibition. The request can be sent via App messaging or SMS.

At step 230, an invitation is sent to the guardian's phone 112 to install a guardian App for managing the temporary disablement requests received at step 228.

In use, the App monitors the location of the driver's phone 102 and report back to the administration server 116. If the driver's phone 102 exceeds the predetermined speed as determined by the speed determination tool 106, the administration server 116 notifies the telecommunication server 108 as the speed is indicative of driving. The administration server 116 checks the inhibition functions associated with the driver's number in the telecommunications database 128, and the telecommunications server 108 inhibits those functions to the driver's phone 102 accordingly.

The notification tool 120 sends the speed notification to the guardian's phone 112 when the driver's phone 102 exceeds an unsafe maximum speed and sends a distance notification to the guardian's phone 112 when the driver's phone 102 travels beyond a predefined radial distance from home.

The driver's phone 102 can still receive calls and texts from the guardian's phone 112 in accordance with the settings of the override tool 122. If the driver 104 elects to become a passenger, the timer tool 126 can be used to temporarily disable the inhibition on the phone 102.

A person skilled in the art will appreciate that many embodiments and variations can be made without departing from the ambit of the present invention.

In one embodiment, the speed determination tool 106, notification tool 120, override tool 122, selection tool 124 and timer 126 can be provided within the driver's phone 102 or within the telecommunications server 108. In one embodiment, there is no need for the administration server 116.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A telecommunications system, the system including:
a mobile phone for use by a driver;
a speed determination tool within the phone for determining the speed of the mobile phone;
a telecommunications company (Telco) for inhibiting a function of the mobile phone when the determined mobile phone speed exceeds a predetermined speed; and
means for enabling a guardian to configure rules associated with the inhibition applied by the Telco to the mobile phone;
wherein individual control is provided by the guardian over the mobile phone of the driver, and that control is applied by the Telco to the mobile phone.

2. A telecommunications system as claimed in claim 1, wherein the system further includes a notification tool for notifying the means about information relating to the driver's phone.

3. A telecommunications system as claimed in claim 2, wherein the information relates to disabling an App executing on the driver's phone, disabling location services relating to the driver's phone and upon which the speed of the phone is determined, the driver's phone exceeding a speed or the driver's phone travelling beyond a predefined distance from home.

4. A telecommunications system as claimed in claim 1, further including an administration server for administering the system.

5. A telecommunications system as claimed in claim 4, wherein the administration server communicates with application software (i.e. Apps) on the phone.

6. A telecommunications system as claimed in claim 1, further including an override tool for overriding the inhibition.

7. A telecommunications system as claimed in claim 6, wherein the overriding tool overrides the inhibition when the function relates to a guardian number or when the phone has a Bluetooth connection.

8. A telecommunications system as claimed in claim 1, further including a selection tool for selecting inhibition options.

9. A telecommunications system as claimed in claim 8, wherein the inhibition options relate to the predetermined speed, the function, the nature of the function, or the forum of the function.

10. A telecommunications system as claimed in claim 1, further including a disablement timer for temporarily disabling the inhibition responsive to approval from a guardian.

11. A method for inhibiting a function of a driver's mobile phone, the method including:
a telecommunications company (Telco) inhibiting the function when the mobile phone exceeds a predetermined speed determined by the phone; and
the Telco applying enforcement rules to the mobile phone, the enforcement rules being associated with the inhibition and being configured by a guardian;
wherein individual control is provided by the guardian over the mobile phone of the driver, and that control is applied by the Telco to the mobile phone.

12. A method as claimed in claim 11, involving selecting the function to be inhibited.

13. A method as claimed in claim 11, involving sending a notification to the guardian when disabling a user App executing the method or location services relating to the phone and upon which the speed of the phone is determined.

14. A method as claimed in claim 11, involving sending a notification when a speed is exceeded or when the phone travels beyond a predefined distance from home.

15. A method as claimed in claim 14, involving setting a guardian number to receive the notification.

16. A method as claimed in claim 11, involving overriding the inhibition when the function relates to a guardian number.

17. A method as claimed in claim 11, involving overriding the inhibition when the phone has a Bluetooth connection.

18. A method as claimed in claim 11, involving setting the predetermined speed from a number of possible speeds.

19. A method as claimed in claim 11, involving selecting the function from a number of possible functions.

20. A method as claimed in claim 19, wherein the function relates to any one or more of: a message or call; receiving or transmitting the message or call; social media; and facebook, twitter, snapchat, Instagram, e-mail or other like communications applications.

21. A method as claimed in claim 11, involving sending a temporary disablement request to a guardian to temporarily disable the inhibition.

22. A method as claimed in claim 21, wherein the guardian can deny or allow the request.

23. A method as claimed in claim 21, wherein the guardian can select a length of time to temporarily disable the inhibition.
